(19) United States
(12) Patent Application Publication
(10) Pub. No.: US 2013/0104241 A1
(43) Pub. Date: Apr. 25, 2013

(54) Devices for Controlling Rendering Protected Content and Related Methods

(71) Applicants: Rolf Blom, Jarfalla (SE); Per-Olof Nerbrant, Osterskar (SE); Goran Selander, Bromma (SE); Clary Hallberg Dahlin, Jarfalla (SE)

(72) Inventors: Rolf Blom, Jarfalla (SE); Per-Olof Nerbrant, Osterskar (SE); Goran Selander, Bromma (SE); Steinar Dahlin, Jarfalla (SE)

(21) Appl. No.: 13/505,358

(22) PCT Filed: Nov. 2, 2009
(86) PCT No.: PCT/SE2009/051235

§ 371 Date: Nov. 2, 2012

(51) Int. Cl. G06F 21/60

(52) U.S. Cl. CPC G06F 21/60
USPC 726/26

(57) ABSTRACT

Devices for providing flexible control of rendering of protected media comprising first and second content objects are provided. An instruction database combines with traditional use of digital rights objects for determining, at rights parsing and instruction handler, conditions for rendering of first content object. Conditions may force the user to render second content objects or to input requested data and may adapt to environmental conditions exemplary relating to user profile, location, or time of day. A set of second content objects may be pre-determined and specified in provided instructions. User selection, from a list of second content objects, of a specified number of second content objects, provides for generation of a key enabling successful rendering of first content object.

### FIELD OF INVENTION

The invention is concerned with the control of rendering of digital protected content. More precisely, the invention is concerned with method and apparatus for imposing condition to render second type of content in order for successful rendering of first type of content.

### BACKGROUND

The distribution of digital content may be made dependent on parallel distribution of associated rights objects (RO) that comprise rules or policies that exercise control of the rendering of the digital content. The Open Mobile Alliance standard, OMA DRM v2, describes a so called Parent- and Child-RO related through an inheritance mechanism. The Parent-RO may be associated with one or more child ROs that specify additional permissions. OMA DRM v2 provides for new ways of controlling rendering of digital content. Exemplary a Parent-RO may be associated with a subscription whereby a Child-RO may associate with exemplary daily updates of certain content. Rendering a daily update content file is, therefore, made in dependence of subscription data as determined by the parent RO. Thus, DRM Parent-RO provides a framework for rendering whereas Child-RO defines additional rights within said framework.

It is desirable to provide digital content for free or at reduced cost if the user renders e.g. commercials at the same time. Marlin DRM system (http://www.marlin-community.com) describes so-called dynamic media zones, where content is associated with specific attributes that must be matched against conditions for access and/or playback. While this gives some degree of control of the rendering conditions, it is based on the matching of constraints represented by attributes associated to certain content and precise positioning in a given media stream. It does not allow more general execution of actions conditioning the rendering of a certain media.

There are limitations to prior art methods for handling conditional rendering and there is, thus, a need for methods providing for a higher degree of flexibility. The present invention combines prior art use of rights management with new features to provide a flexible method and arrangement for control of rendering protected content.

### SUMMARY

The present invention provides a convenient method and arrangement that is useful for conditioning the rendering of digital protected content with the rendering of other associated content such as commercials. In particular, the present invention extends prior art methods and provides a much more diversified range of conditions.

A device and method is disclosed for rendering of protected content comprising a first content part, hereinafter also referred to as dependent content part, DC, and at least a second content part hereinafter also referred to as independent content part, IC. Rendering of respective dependent and independent content parts are due to rules or conditions as specified in corresponding rights objects hereinafter referred to as dependent rights object, DRO, and independent rights object, IRO, respectively. The device may include an instruction database providing for high degree of flexibility in managing control of rendering. Rights parsing and instruction handler at the device processes instructions and rights information provided in the rights objects and has capability to generate conditions for the rendering of dependent content. The rights parsing and instruction handler provides control information to content handling and rights enforcement means whereby said conditions may enforce conditional rendering of at least an independent content part before rendering of dependent content is allowed to commence or to continue.

According to various alternative embodiments of the invention the conditions for conditional rendering of dependent content parts are determined in part from information provided in a dependent rights object or dependent content part and in part from instructions downloaded together with content or at initiation of a streaming session.

According to another embodiment rendering of dependent content require presence of key information made available as result of the rendering of pre-determined independent content objects.

According to an alternative of said another embodiment, said key may be determined from information parts obtained from rendering of a pre-determined number of independent content parts. The pre-determined independent content parts may be determined from a list of selectable independent content parts from which a user is offered to select a pre-determined number of items. The list may be generated by content provider and may depend on user profile, time of day, or location as determined exemplary from GPS-data. Said information parts may comprise parts of a secret sharing system. This embodiment provides for adaptation of conditioned rendering of independent content parts to, exemplary, user profile, location information, or time of day.

According to still another embodiment, at least an independent content object comprises executable software. Rendering of executable software object causes computer means to execute instructions therein for implementing a variety of functions. Exemplary, a user may enter a dialogue session for making a commercial agreement, for responding to a questionnaire, or for playing an interactive game. Depending on result of dialogue a key may be obtained. Exemplary, the user completes at least part of questionnaire, completes a commercial agreement, or attains pre-determined result of interactive game. FIG. 9 shows a flow diagram of a method according to the invention. Like numerals correspond to like numerals in FIG. 6. At 640 independent objects are loaded e.g. according to instructions loaded in step 620. According to embodiment, the independent content comprises executable software that establishes a user dialogue at step 910. The user dialogue may result in user input received at step 920. At step 930, conditions are determined for rendering of dependent content. The conditions may depend on the user input and, at least partly, on loaded instructions in step 620. Step 920 may, e.g., include a step of verifying user input such as verification of payment of fee for eliminating requirement to render at least an independent content part. The step 930 of determining may include generation of a key required for rendering of DC.

Alternatively, executable software may determine a location and instruct the user how to reach the location. When the determined location agrees with the actual location, exemplary as determined from GPS-data, the required key information is obtained for rendering of desired dependent content. By allowing for executable software, as described, new functionality may be included in a system for control of rendering protected content.

According to yet another embodiment, an operator may provide dependent content at specified price. The dependent content may include a list of independent content objects provided by third party. The operator may implement the GBA infrastructure according to 3rd Generation Partnership Project, 3GPP TS 33.220. A user may obtain dependent content and said list and generate a key for communication with third party. A user may contact third party to obtain selected independent content. Third party may request same said key from the operator and provide user with independent content, exemplary commercials, over communication protected using said key. At completion of commercials, user may obtain a key or key part from third party enabling generation of key for rendering of the initially acquired dependent content object. The embodiment opens up for new business models exemplary involving an operator, providing network communication and content, and third party providing commercial information related to third party business.

### DESCRIPTION OF DRAWINGS

FIG. 1 shows a prior art arrangement.

FIG. 2 illustrates an embodiment of the present invention.

FIG. 3 shows prior art basic structure of a GBA-system.

FIG. 4 is a flow chart illustrating an embodiment of the invention based on GBA.

FIG. 5 illustrates exemplary embodiment of inventive Rights parsing and instruction handler.

FIG. 6 is a flow diagram of a method according to the invention.

FIG. 7 is a more detailed flow diagram of a method according to the invention.

FIG. 8 is a flow diagram of an alternative method according to the invention.

FIG. 9 is a flow diagram of another alternative method according to the invention.

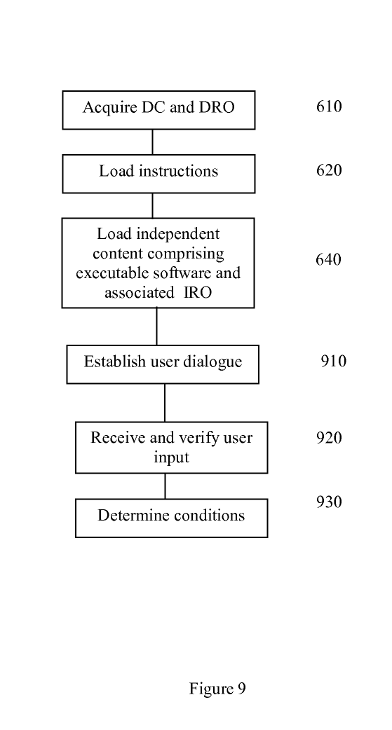

### DETAILED DESCRIPTION

The following definitions will be used throughout the remaining of this document. Dependent content (DC) is content which will be successfully rendered on condition that other content, hereinafter referred to as independent content (IC) is rendered conditionally according to specified conditions. Rendering of dependent content is subject to requirements specified in associated dependent rights object (DRO). Rendering of the other content is, analogously, subject to requirements according to associated independent rights object (IRO).

A typical use case related to the present invention comprises a user who buys or rents a DVD movie at reduced price and agrees that to view the movie at a reduced price he/she accepts to render a specified amount of other content such as commercials. However, depending on amount paid, he may exercise some control of type of commercial content interspersed in the rendering of the movie. Further, the commercials may be adapted to the context in which the movie is rendered, e.g. time of day, type of rendering device, geographic location. Context adaptation of e.g. commercials may require network connectivity in order to access and download or stream appropriate commercials.

With reference to the use case above it is noticed that any IC usually can be rendered independently of the dependent content such as a movie. However, a more reasonable scenario is that the IC is only rendered to fulfill conditions for successful rendering of a desired DC.

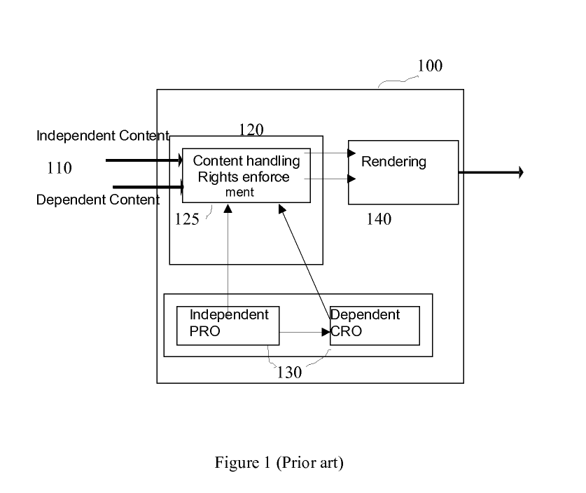

FIG. 1 illustrates typical prior art arrangement 100, based on child and parent rights objects, for rendering of digital protected content. At 110 content is input to content handling means 120 including content handling and rights enforcement means 125. In the case of subscribed information there is only one content input to the system and the rendering of the subscribed content is under control of the parsed rights as specified in the independent and dependent rights objects. The rights objects, PRO and CRO, may be stored at corresponding entities as indicated. There is shown a communication link between PRO and CRO to indicate that CRO may depend on PRO, e.g. through inheritance of rights information. The means 120 enforces rights according to rights objects PRO and CRO. Exemplary, if PRO is associated with a subscription, CRO may only be valid if inherited time of validity, as specified by PRO, so indicates. A rendering unit 140 renders content according to specified limitations, exemplary quality of rendering, rendering time or volume of data allowed for rendering. The structure described in FIG. 1 may exemplary be implemented according to the OMA DRM standard (http://www.openmobilealliance.org). A typical use case for the arrangement according to FIG. 1 comprises a user subscription framework specified in a parent rights object PRO exemplary specifying time validity of subscription or number of magazine issues subscribed to. Child rights object CRO may specify e.g. daily newspaper or weekly magazine issues subscribed to. It is noticed that the prior art arrangement provides a framework for management of content rights such that a parent rights object imposes overall rights whereas content is rendered within the framework under common control of PRO and CRO.

The Marlin DRM system (http://www.marlin-community.com) allows a similar setup of rendering conditions, with the addition of the use of Dynamic Media Zones. Dynamic media zones are determined positions in the content which allow for dynamic population of media. This allows content associated with specific attributes to be matched against conditions for access and/or playback. The license determines how a media zone within the content is to be populated and viewed, e.g. advertisements that must not be skipped or warning screens that must be viewed. It also allows content available on different terms based on insertion of personalized ads inserted in a media zone.

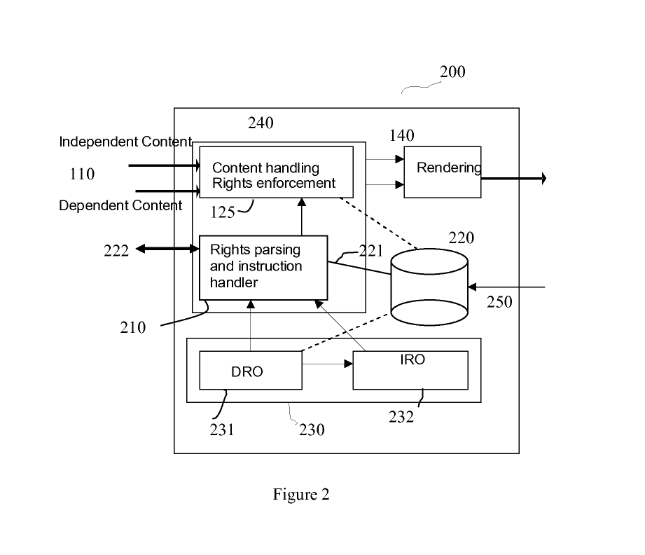

Turning now to FIG. 2, there is shown a first embodiment of the present invention. In FIG. 2, like numerals indicate like entities as in FIG. 1. FIG. 2 shows at 230 implementation of rights objects DRO and IRO respectively. The content handling means 240 includes a rights parsing and instruction handler 210.

The rights parsing and instruction handler 210 parses rights according to DRO and IRO respectively and implement additional control according to instructions obtained over communication links 221 and 222 where the latter link provides for communication with UE. The rights parsing and instruction handler has capability to establish a dialogue with a user of UE over communications link 222. Communications link 222 may also be used for communication with network entities through means at UE for that purpose. Control information from rights parsing and instruction handler 210 is input to the content handling rights enforcement means 125 enforcing control actions.

An instruction database 220 stores instructions associated with rights object DRO. The instructions are provided to the rights parsing and instruction handler 210 for, at least partly, determining conditions and for control of conditional rendering of independent content, IC through control actions. The instruction database 220 is preferably part of DRO indicated by a dashed line in FIG. 2. However, the instruction database is here shown as an independent entity to indicate flexibility in the management of instructions which may be adapted to a user profile, time of day, or location, or by presenting a dialogue to the end user for requesting certain information to be provided on communications link 222. Implemented as an entity external to DRO the instruction database may load instructions into DRO or, alternatively, load the rights parsing and instruction handler over another communications link (not shown in FIG. 2). In any case, the association between a specific DRO and related set of instructions may be established through an identifier.

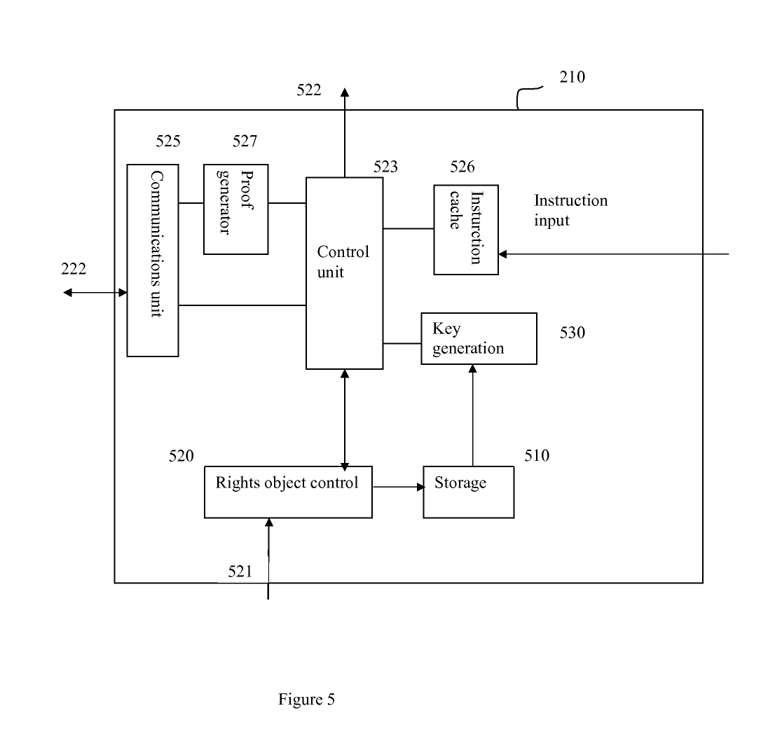

FIG. 5 shows in more detail an exemplary embodiment of the rights parsing and instruction handler. A rights object control compiles rights information from the respective rights objects DRO and IRO. The rights object control may extract key parts from a rights object and store the same in storage unit 510. A communications unit 525 manages communication over communications link 222 with external entities preferably at UE. The communications unit may also control a user dialogue for receiving additional input for determining control information. An instruction cache 526 fetches instructions, related to the DRO being processed, from the instruction database 220. A key generation unit 530 may generate a key from key parts stored at storage 510. A control unit 523 manages control of the different units of means 210 and may also determine, from rights object control information and instruction cache, conditions for rendering dependent contents. The control unit generates control information according to the determined conditions for control, over communications link 522, of content handling and rights enforcement means 125. A proof generator 527 generates proof that a specific independent content object has been rendered. The proof may include identifier of third party, identifier of user, and a digest of the independent content object e.g. a hash of the content. The proof may be protected by using a key embedded in DRO. The proof may be sent, using communications unit 525, to the operator or to the third party.

DRO generally imposes limitations related to the actual rendering of content such as number of times, quality paid for, or volume paid for whereas the instruction database, according to the invention, may provide for dynamic and changeable aspects. Exemplary instruction may impose a condition to access independent content at an identified address and render at least a specified part of the accessed independent content part. Until specified conditions are satisfied, rendering of dependent content part is interrupted.

According to first alternative embodiment, said instructions are included in the dependent rights object, DRO.

According to second alternative embodiment, said instructions are determined from information contained in the dependent content part 110, said information extracted there from over the link 221 at download of content or, initially, at commencing a streaming session.

According to third alternative embodiment, said instructions are loaded over a communications link 250 e.g. at preparing for content download or streaming.

According to a second embodiment of the invention the IC contains keys that are needed for successful rendering of the DC. It is common in the art to encrypt content and to provide the key for decryption in a rights object. According to the second embodiment, the decryption key or information allowing retrieval of or derivation of the key is made available from an independent rights object at completed rendering of the corresponding independent content, IC. Reference is now made to FIG. 5. At 521 an independent rights object is fetched to the rights object control 520. The rights object control extracts a key information part from the independent rights object and stores the extracted part in storage means 510. At 522 the control unit communicates with the rights enforcement means 125. The rights enforcement means 125 may inform rights control unit 523 of completed rendering of the corresponding independent content whereupon the control unit, may request key generation means 530 to fetch key elements from storage means 510 and there from generate a key that enables rendering of dependent content object to continue. The key may be transferred to rights enforcement means 125 over the link 522.

In particular, according to an alternative of the second embodiment, rendering of an independent content object provides only part of a complete decryption key. Therefore, according to this alternative, a predetermined number of independent content objects must be rendered in order to obtain a complete decryption key. Each independent content object provides a part key stored in storage means 510. Exemplary, the part keys may be parts according to a shared secret method wherein a per-determined number of parts allow generation of a complete key. A user may be presented with a list of independent content objects to select from and be provided with an instruction to select any of specified number content objects from the list. The list may be generated at communications unit 525 and communicated to the user over communications link 222. User selection from the list is likewise communicated over the link 222. The control unit 523 receives acknowledge from the content handling and rights enforcement unit 125 of each rendered independent content object. At successful rendering of all selected content objects a key is obtained from key generation means 530 that is required for rendering of a desired dependent content object. The list of selectable content objects may further be adapted to a user context exemplary related to a user profile, time of day, or location. According to this embodiment control unit instructs user through link 222 to render additional independent content objects if not a sufficient number of stored key information parts can be obtained from storage 510.

According to another alternative of the second embodiment, the rendering of the DC is based on the amount of independent content that has been rendered during a given time period. The Content handling and Rights enforcement means 125 may inform control unit 523 over the link 522 of the amount of rendered content.

According to a third embodiment an independent rights object is designed as executable software establishing a user interaction wherein a user may provide specified input required for generation of the key required for rendering of dependent content. In FIG. 5 the control unit 523 may execute instructions provided in executable software. The instructions may be obtained from Rights object Control 520 over a communications link. The executable software may cause the control unit to establish, through communications unit 525, a user dialogue.

According to a first alternative of the third embodiment, the executable software offers the user to pay an additional fee in order to obtain the key and eliminate the need to render one or more independent content objects e.g. commercials.

According to a second alternative of the third embodiment the executable software may establish user interaction for signing a commercial agreement to obtain a key, required to render e.g. a movie, the commercial agreement may exemplary involve subscribing for a weekly magazine.

According to a third alternative of the third embodiment, the executable software may provide a location identifier, e.g. geographical coordinates, and a mobile user may be informed through communications unit 525 that navigating to the location enables rendering of dependent content. A mobile user may use navigation means, e.g. a GPS navigator, to reach the identified position. The software may include data that combined with the geographical position, causes Key generation means 530 to generate a key for rendering of dependent content. Preferably, the generation is performed such as to eliminate the possibility for the user to falsely pretend to be at the identified location. However, a solution to this problem is out of scope of the present invention.

According to a fourth alternative of the third embodiment the executable software comprises a questionnaire provided to the user through communications unit 525 and communications link 222. Upon completion of the questionnaire or attaining a pre-determined goal key material is made available enabling rendering of dependent content.

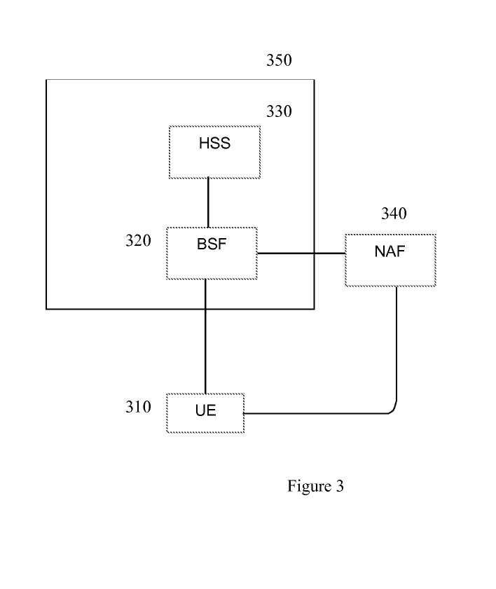

According to a fourth embodiment the GBA infrastructure is utilized to manage security objects and conditions for rendering. FIG. 3 illustrates the basic structure of the GBA method as specified in the standard 3GPP TS 33.220. A user entity UE 310 authenticates with a Bootstrapping Server Function BSF 320 at the operator, illustrated at 350, using a shared key implemented at UE and at the operator Home Subscriber System HSS 330. The authentication process also results in shared key Ks. The operator may cooperate with one or several NAF entities 340 representing service providers. At authentication, according to GBA, a pointer B-TID is generated at BSF and at the user terminal, the generation being based on a random number used in the authentication process and available to both the user entity and to BSF. The identifier B-TID may be used to recover the key Ks from BSF. A user entity UE may request services from a selected NAF thereby first generating a NAF specific key Ks_NAF and thereafter requesting services by providing NAF with the pointer B-TID. NAF, at reception of the request, communicates with BSF using cooperative arrangement with the operator and forwards the pointer B-TID. BSF may then retrieve the key Ks and generate the key Ks_NAF which is returned to NAF thereby proving that UE has authenticated. UE and NAF may thereafter communicate securely based on the shared key Ks_NAF.

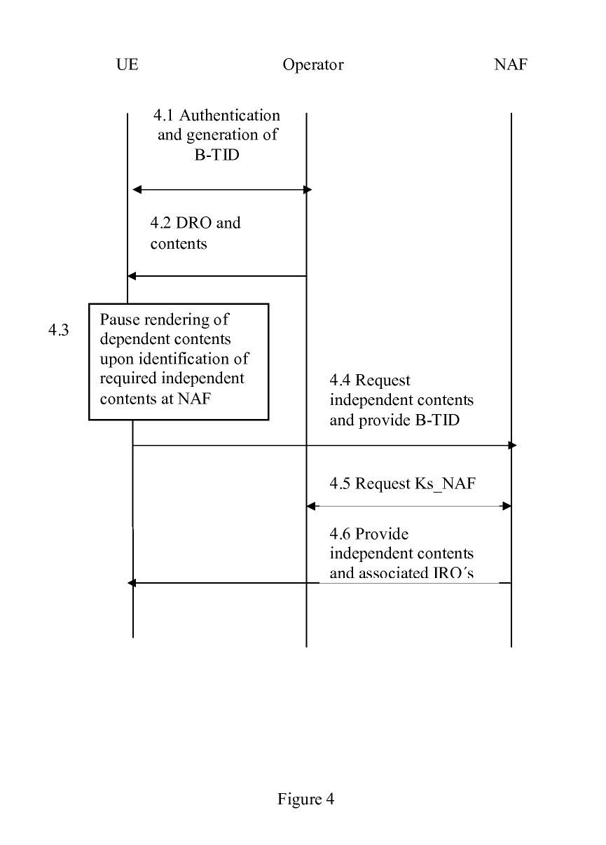

According to the fourth embodiment, UE may obtain and pay for dependent content provided by the operator based on a subscription with the operator. A dependent rights object DRO may be obtained from the operator exemplary encrypted with a key derived from Ks, e.g. Ks_NAF. The dependent rights object DRO may include a list of independent rights objects IROs associated with at least one service provider NAF. A method according to the third embodiment is illustrated in FIG. 4. At 4.1 UE authenticates with operator. At 4.2 UE receives dependent content and associated rights object DRO. Reception of content is usually on condition that payment is made. At 4.3 UE renders content subject to DRO control. At 4.4, UE requests at NAF independent content, as ruled by DRO, in order to continue rendering of dependent content. NAF forwards 4.5 B-TID, received in the request 4.4, in a request to operator for a key Ks_NAF. At 4.6 independent content and associated rights object IRO is provided to the user UE. The communication between NAF and UE may be protected using the key Ks_NAF or a key derived there from.

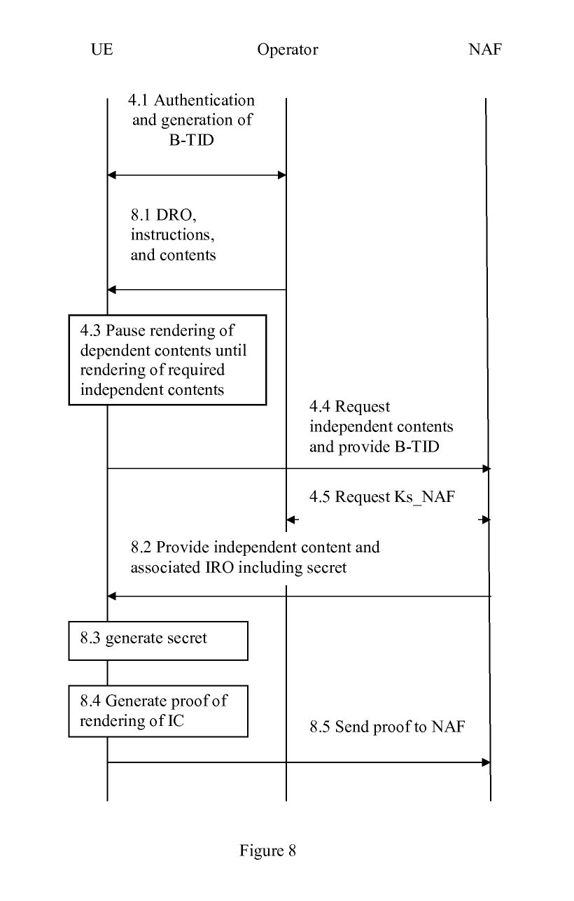

An alternative of the fourth embodiment is illustrated in FIG. 8 wherein like numerals correspond to like numerals in FIG. 4. In step 8.1, the NAF may impose instruction to identify parameter (e.g. message digest of known information such as independent content IC using a one-way function) encrypted with Ks_NAF. The rendering of dependent content may be conditioned on the presence of the parameter. In step 8.3 independent content, provided in step 8.2, is rendered and the parameter may, thereupon, be re-generated. Upon identification of the appropriate parameter the rendering of dependent content may continue exemplary by control of rights parsing and instruction handler 210. In step 8.4, proof is generated of the rendering of the independent content. At 8.5 the proof is sent to NAF.

The alternative embodiment described is useful in a business arrangement in which the third party NAF has a business relation with the operator wherein third party compensates operator for providing dependent content at a reduced price under condition that independent content, e.g. commercials, associated with third party is conditionally rendered. Based on the relation between the operator and third party, operator embeds in DRO said secret.

According to the embodiment, a user entity, UE, may provide proof of rendering third party independent content. For example, with reference to FIG. 5, control unit 523 may prepare log means at completed rendering of independent content IC including NAF identity (i.e. identity of third party), digest of IC (exemplary a hash value), and identity of user (exemplary obtained from SIM or USIM card at UE). The log means may be protected by a key obtained from DRO and the log may be sent to the operator or to third party through communications means at UE.

According to another alternative of the fourth embodiment a method is disclosed to bind the rendering of a DRO and a sequence of IROs e.g. commercial intermissions in a film to a particular UE. The NAF generates iterates of a secret parameter under a one-way function, such as a secure hash function i.e. if “r” denotes the secret parameter and “h” is a hash function the sequence S₀=h(r), S₁=h(S₀) . . . Sₘ=h(Sₘ₋₁). The final value Sₘ is included in the DRO (in clear text or encrypted with Ks_NAF), and there is a condition that successive pre-images of the hash chain is required for subsequent rendering. For each IRO in turn, the previous pre-image Sₓ of the hash chain is included, encrypted with Ks_NAF. The rights parsing agent iterates the value coming in the IRO the required number of times and compares with the final value Sₘ in the hash chain or a cached pre-image. Since the ability to decrypt the encrypted hash chain values is restricted to the UE, rendering requires the involvement of the UE.

In any of the previous embodiments the arrangement 200, may be implemented in a tamper proof entity in order to prevent tampering with security data or to falsely simulate completed execution of independent content objects.

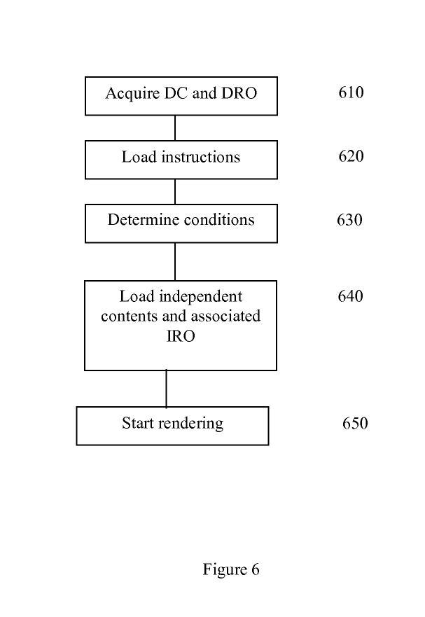

FIG. 6 is a flow diagram of a method according to the invention. At 610 a user may request wanted content, DC and acquire rights object DRO corresponding to the content. The user may obtain DRO through known methods, usually involving a commercial agreement with the content provider including payment. At 620 instructions are loaded for control of conditional rendering. Exemplary, Rights parsing and instruction handler 210 may initiate and control the loading. At 630 conditions for rendering DC are determined at least in part using the loaded instructions. At 640 independent content parts and associated independent rights objects are obtained as specified by the determined conditions. Usually rights objects IRO associated with independent content are free to download and are not liable to any commercial agreement. At 650 rendering commences. Depending on the determined conditions and specifications provided in DRO and IRO the rendering is performed in a variety of different ways. Exemplary, rendering of DC may commence to be interrupted at a certain time when rendering of a second independent content part is started. At completed rendering of the independent content part, rendering of DC may continue.

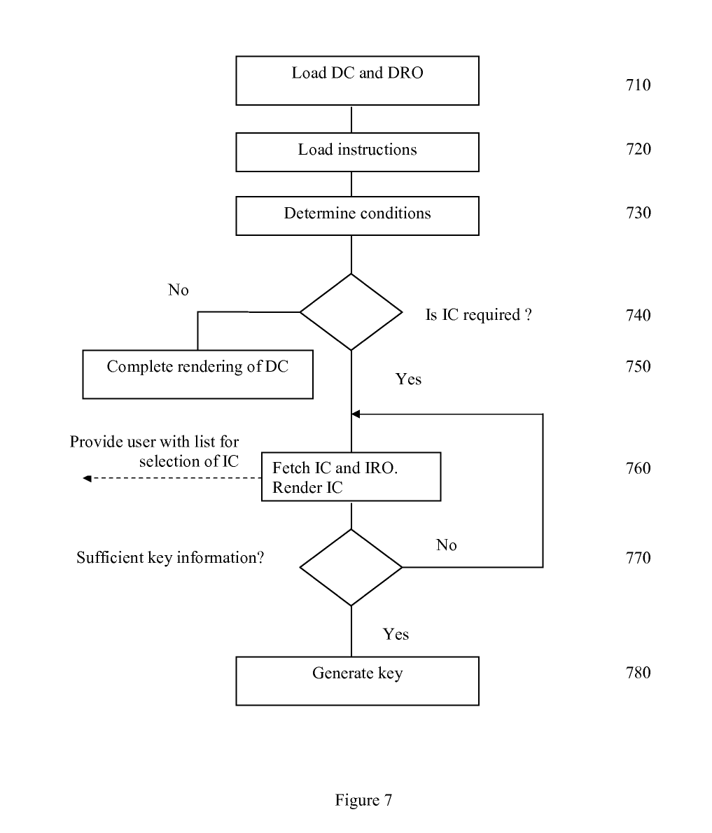

FIG. 7 shows in more detail a method according to the invention. At step 710 a user obtains wanted dependent content DC. A corresponding DRO is also acquired. At step 720 instructions are loaded for control of conditional rendering. At step 730 rendering of the DC is initiated. The rendering may be interrupted according to the instructions. At step 740 it is determined from the instructions and/or DRO if independent content is required in order to obtain rights for continued rendering of DC. If independent content is required this is loaded and rendered at step 760 according to corresponding IRO. The user may be presented with a list for selection of IC. At step 770 it is determined if sufficient independent content has been rendered for allowing generation of key allowing for continued rendering of dependent content DC. If this is not the case, the process returns to step 760 for loading of additional independent content. At step 780 a key is generated when sufficient key information has been obtained from the rendering of independent content. If, on the other hand, no IRO is required as determined at step 740 the rendering of DC may complete.

The invention advantageously offers great flexibility in management of rights for rendering specified content. The inventive advantages are obtained from combining usage rights provided in dependent and independent rights objects. Rights parsing and instruction handler is introduced for parsing rights provided through said rights objects. An instruction database provides rights parsing and instruction handler with control information. The instruction database may be loaded with instructions preferably under control of the content provider.

The invention advantageously offers new business models whereby rendering of commercials enables rendering of dependent content. In the case of managing security data, such as keys, according to the GBA infrastructure, an operator may sign commercial agreements with third parties whereby third party pays a fee to receive a key for protected communication of commercials to the user. The operator may, correspondingly, lower the price to the user for the requested dependent content on condition that the user renders at least a commercial.

From a reading of the above detailed description of the invention it is clear that a person skilled in the art may obtain numerous alternative embodiments of the invention which is defined by the following claims.

1. A device for rendering of protected content compiled from a first dependent content part and at least a second independent content part, the device including means for accessing the first and second content parts, wherein at least the second independent content part comprises executable software for establishing a user dialogue, the device comprising:
means for implementing a first dependent rights object and at least a second independent rights object;
means for enforcing rights according to the implemented first and at least second rights objects;
means for storing instructions associated with the first dependent rights object; and
means for determining, at least partly in dependence of the instructions, conditions for rendering of the first content part, the conditions enforcing rendering of at least a second content part as requirement for complete rendering of the first dependent content part.

2. The device of claim 1, wherein the device is implemented in a tamper proof entity.

3. The device of claim 1, wherein the means for determining further comprises:
means for extracting a key part from an independent rights object and means for storing the extracted key part; and
means for generating a key from stored key parts.

4. The device according of claim 1, wherein the means for determining comprises means for generating proof of rendering of the at least second content part.

5. A method for rendering, at a user entity (UE), of protected content comprising a first dependent content part and at least a second independent content part, the method comprising:
downloading, at the user entity first dependent content part and associated dependent rights object (DRO);
loading instructions;
determining, at the user entity, at least in part from loaded instructions, conditions for conditional rendering of dependent content part;
downloading, at the user entity, at least a second independent content part and associated rights object (IRO), wherein the at least a second independent content part comprises executable software for establishing a user dialogue;
establishing a user dialogue; and
starting at the user entity rendering of dependent and independent content parts according to determined conditions.

6. The method of claim 5, wherein the instructions are loaded from the dependent rights object.

7. The method of claim 5, wherein the instructions are loaded from the first dependent content part.

8. The method of claim 5, wherein the instructions are loaded over a communications link.

9. The method of claim 5, wherein rendering of the second independent content part provides information for generation of a key for rendering of the first content part.

10. The method of claim 9, wherein rendering of the second content part provides a part of the key and a pre-determined number of such parts enables generation of the key.

11. The method of claim 10, wherein a user is presented with a list of second independent content parts whereby selection for rendering the pre-determined number of second content parts provides parts of a key for generation of the key.

12. The method of claim 11, wherein the list of second independent content parts is adapted to a user context.

13. The method of claim 5, wherein the executable software at least in part establishes a user dialogue wherein user input is provided affecting generation of the key.

14. The method of claim 13, wherein the user input is verified for eliminating at least partly conditions for rendering the second independent content part.

15. The method of claim 5, further comprising generating proof of rendering of an independent content object.
